(19) United States
(12) Patent Application Publication
(10) Pub. No.: US 2026/0200812 A1
(43) Pub. Date: Jul. 16, 2026

(54) POLYHALITE GRANULES CONTAINING NITROGEN

(71) Applicant: ANGLO AMERICAN WOODSMITH LIMITED, London (GB)

(72) Inventors: Rafaella da Fonseca RODRIGUES, London (GB); Timothy David LEWIS, London (GB)

(21) Appl. No.: 19/135,461

(22) PCT Filed: Dec. 6, 2023
(86) PCT No.: PCT/IB2023/062288

§ 371 Date: Jun. 4, 2025

(30) Foreign Application Priority Data
Dec. 7, 2022 (GB) 2218397.4

(51) Int. Cl. C05D 1/00; C05C 1/02; C05G 3/20; C05G 3/30; C05G 5/12; C05G 5/30

(52) U.S. Cl. CPC C05D 1/005; C05C 1/02; C05G 3/20; C05G 3/30; C05G 5/12; C05G 5/38

(57) ABSTRACT

The invention provides a process for the preparation of polyhalite granules comprising the steps of providing an aqueous ammonium nitrate (AN) solution; heating the solution to produce a hot solution; adding the hot solution to polyhalite; and allowing the mixture to cool during a granulation process. The invention further provides a process for the preparation of polyhalite granules where polyhalite is granulated with ammonium nitrate to form potassium nitrate, calcium ammonium nitrate, ammonium nitrate and/or magnesium nitrate and ammonium sulphate and a polyhalite granule comprising polyhalite and potassium ammonium nitrate.

### INTRODUCTION

This invention relates to polyhalite granules and a process for the manufacture thereof. The polyhalite granules comprise polyhalite and ammonium nitrate and are manufactured in a process utilising a hot ammonium nitrate solution.

### BACKGROUND OF THE INVENTION

To grow properly, plants need nutrients (nitrogen, phosphorus, potassium, calcium, zinc, magnesium, iron, manganese, etc.) which normally can be found in the soil. Sometimes fertilisers are needed to achieve a desired plant growth as these can enhance the growth of plants.

This growth of plants is met in two ways, the traditional one being additives that provide nutrients. The second mode by which some fertilisers act is to enhance the effectiveness of the soil by modifying its water retention and aeration. Fertilisers typically provide, in varying proportions, three main macronutrients viz.
Nitrogen (N),
Phosphorus (P), and
Potassium (K),
   and three secondary macronutrients, viz.
Calcium (Ca),
Magnesium (Mg), and
Sulphur (S).

In addition, micronutrients such as copper (Cu), iron (Fe), manganese (Mn), molybdenum (Mo), zinc (Zn), boron (B) are often also included. Of occasional significance there is silicon (Si), cobalt (Co), and vanadium (V) and some rare mineral catalysts.

The most reliable and effective way to make the availability of nutrients coincide with plant requirements is by matching their release into the soil solution to the demand of the plant, typically using slow release or controlled release fertilisers.

Although both slow-release fertilisers (SRF) and controlled release fertilisers (CRF) supply nutrients gradually they differ in many ways including the technology they use, the release mechanism, longevity, release controlling factors and more.

Solid fertilisers include granules, prills, crystals and powders. Of these products, granules are preferred and have been widely used as they allow for easier application via spreading onto the soil surface and can release nutrients into the root zone throughout crop development over time.

Polyhalite is an evaporite mineral, a hydrated sulphate of potassium, calcium and magnesium with the formula: K₂Ca₂Mg(SO₄)₄2H₂O. Polyhalite is used as a fertiliser since it contains four of the important macro nutrients.

Commonly known processes to make granules are:
Wet granulation: a liquid or a solution with a binder is used to promote agglomeration following which the product is dried and screened.
Dry granulation: a binder and/or pressure is used to produce granules without any liquid addition, for example using compaction or extrusion. The particles can subsequently be milled, grazed or screened to reach a desired particle size distribution.
Hot melt granulation: a subdivision of wet granulation where the binders are molten to facilitate nucleation. This route allows higher productivities due to an increase in granulation efficiency combined with a strong reduction in dryer capacity requirements (dryer capacity can be a bottleneck for many granulation plants).

A need exists for a granulation process which addresses several of the disadvantages known in the art, including using less water, reducing energy demand and increased granulation efficiencies.

### SUMMARY OF THE INVENTION

According to a first aspect to the present invention there is provided a process for the preparation of polyhalite granules comprising the steps of:
a) Providing an aqueous ammonium nitrate (AN) solution;
b) Heating the solution to produce a hot solution;
c) Adding the hot solution to polyhalite;
d) Allowing the mixture to cool during a granulation process.

The polyhalite granules may comprise nitrogen in ammoniacal and/or nitric forms.

Ammonium nitrate (AN) is a chemical compound with the chemical formula NH₄NO₃. AN accounts for more than 15% of the nitrogen fertiliser demand worldwide. It is a white crystalline salt consisting of ions of ammonium and nitrate. It is highly soluble in water and hygroscopic as a solid, although it does not form hydrates.

Although AN is less concentrated than urea in terms of nitrogen content, and urea is also cheaper, AN is more suitable since it contains nitrogen in both ammoniacal and nitrate forms (as required by plants) unlike urease from urea. This characteristic ensures less ammonia and N₂O loss compared to losses by urease to the atmosphere.

The aqueous AN solution may be of any concentration but is preferably concentrated to above 90% by weight AN, more preferably between about 91.3-98.3% and most preferably around 92% by weight AN (w/w).

The AN solution is heated to improve the solubility of AN in water and then granulated with polyhalite. This mixed provides extra nutrients like potassium, sulphur, calcium and magnesium to the final product and at the same time extends the temperature in which the transition phases occur for AN, to improve the safety of the product during process and storage.

The hot AN solution may be added in a ratio of about 50:50 to about 95:05 by weight, more preferably about 60:40, most preferably about 65:35 to the polyhalite (AN solution polyhalite).

The AN solution is preferably heated to a temperature of at least 100 deg C. and preferably between about 126 and about 160 degrees Celsius (deg C.), more preferably between about 145 and about 150 deg C.

The process may include the step of coating the granules with an oil/wax and/or talc combination to prevent moisture uptake, caking and dust generation.

The process according to the invention may include the step wherein the polyhalite granules are screened for physical size with over and under size granules being sent to a recycle circuit.

The polyhalite may be in combination with a source of potash, for example potassium chloride, potassium nitrate, langbeinite and/or potassium sulphate and/or other potassium bearing minerals/substances.

The polyhalite granules may further comprise boron, colemanite, ulexite, or any combination thereof, and/or zinc oxide or zinc sulphate and molybdenum (as ammonium molybdate or sodium molybdate dihydrate). In one embodiment, boron, colemanite, ulexite, or any combination thereof, and/or zinc oxide or zinc sulphate and molybdenum (as ammonium molybdate or sodium molybdate dihydrate) may be added to the polyhalite and/or polyhalite hot AN mixture.

The boron may be present in an amount of 0.1% (w/w) to 1.0% (w/w), preferably 0.2% (w/w) to 0.8% (w/w) and even more preferably 0.3% (w/w) to 0.5% (w/w).

The zinc may be present in an amount of 0.1% (w/w) to 1.0% (w/w), preferably 0.1% (w/w) to 0.5% (w/w) and even more preferably 0.1% (w/w) to 0.3% (w/w).

The polyhalite granules prepared according to the invention may typically have a particle size range of about 1.0 mm to about 6.0 mm, preferably from 2.0 mm to 4.0 mm, and even more preferably 2.7 mm to 3.1 mm.

The average particle size of the polyhalite granules may be from about 1 mm to about 3.5 mm, preferably 2 mm to 2.4 mm, preferably 2.5 mm to 3.5 mm, preferably from 2.6 mm to 3.1 mm, and even more preferably 2.7 mm to 2.8 mm.

The granulation process may be carried out using a granulator selected from a drum granulator, but different equipment can be used for example, a pan granulator, prill tower, intensive mixer such as an Eirich (Registered Trade Mark) intensive mixer, high shear, fluidized bed, hot and cold spherodizer or any other kind of equipment or combination capable of producing granules.

The process according to the invention may further include use of a drier. The drier conditions will depend on the AN:polyhalite ratio. For the range claimed (between 50-95% by weight of AN) the inlet temperature should be about 150-300 deg C., more preferably in the range of about 150-275 deg C. even more preferably in the range of about 150-200 deg C. and should not be higher than about 300 deg C. to avoid decomposition of the ammonium nitrate. The outlet temperature of the gases can be as high as 125 deg C., but should preferably be between about 90-100 deg C.

The granulator pH may be controlled and may be higher than about 4.5 and even more preferably above about 5.0.

The process according to the invention may follow a conventional drum granulation process whereby solid polyhalite powders and recycle are fed onto a drum granulator. The hot AN solution may be fed into the granulator through a sparger.

According to a second aspect to the present invention there is provided a polyhalite granule comprising potassium ammonium nitrate. (Nitrammite or Gwihabaite is the mineralogical name for (NH4,K)NO3). The granule may comprise at least 10% w/w, 20% w/w, 30% w/w, 40% w/w or 50% w/w potassium ammonium nitrate. The granule may be produced by a process according to the present invention.

The granules may further comprise potassium nitrate, calcium ammonium nitrate, ammonium nitrate and/or magnesium nitrate.

The polyhalite granules may comprise nitrogen in ammoniacal and/or nitric forms.

According to a third aspect to the present invention there is provided a process for the preparation of polyhalite granules where polyhalite is granulated with ammonium nitrate to form potassium nitrate, calcium ammonium nitrate, ammonium nitrate and/or magnesium nitrate.

### DESCRIPTION OF PREFERRED EMBODIMENTS

The present invention looks to offer an alternative to agglomeration with binders through adhesion of mineral particles and instead uses solidification of particles within a mixture of a hot AN solution and mineral polyhalite during a granulation process, for example, a drum granulation process.

The invention uses a hot ammonium nitrate (AN) solution that is concentrated from 92% to 98% by weight AN to bind together polyhalite powder and/or granules. The use of AN in the present invention works by solidification/crystallisation as the hot material cools during granulation, and the heat of crystallisation is used to evaporate the water from the AN solution and the water added to promote granulation due to correct gas flow conditions inside the spherodizer.

Without being bound by theory, the applicant believes that the polyhalite provides a solid bed where the AN solution will crystalise while it is cooling. Between 105-108 deg C. AN will start to crystallise/solidify and at the same time the polyhalite will supply Mg, K, S and Ca, which elements can react with AN and will behave like additives to change the AN crystallisation curve, providing stabilisation against thermal disintegration.

In one embodiment of the present invention the proportion of 65% AN: 35% polyhalite by weight was used.

Without being bound by theory, the applicant is of the view that the present process may result in the creation of other nitrates in the granule such as potassium ammonium nitrate, potassium nitrate, magnesium nitrate, calcium nitrate and calcium ammonium nitrate (CAN) and ammonium sulphate through chemical reactions happening during the process.

The granulation of ammonium nitrate and polyhalite can be understood as a combination of wet and melt granulation, where ammonium nitrate is not melted, but an aqueous solution is heated to further increase the solubility of the AN in water, creating a hot solution with 92-98% (w/w) of AN. As a result, the requirements of water to granulate are smaller than in a wet granulation. This characteristic added to the heat released by AN crystallisation drastically reduces the demand of energy to dry the product into the moisture ranges required (less than 0.3%).

Some advantages of a process according to the present invention include:
The hot ammonium nitrate solution is used as a liquid phase to promote nucleation of the powder polyhalite.
To provide a solid bed where ammonium nitrate will crystallise during phase transition that will start to occur when the bed temperature is reduced to about 105
108 deg C.
Polyhalite provides other nutrients to the final product (for example, Mg, K, Ca and S).
The other nutrients act like an additive for ammonium nitrate, providing more stability, and increasing the temperature where phase transitions occur.
The other nutrients stabilise the phase temperature of the AN crystallisation profile (which occurs approximately in 32 deg C.). This results in granules breaking down less during long term storage due to thermocycling.

### DRAWINGS

FIG. 1 is a diagrammatic mass balance of the process according to the invention.

FIG. 2 is a diagram of the process according to the invention.

FIG. 3 is a photograph of non-coated granules according to the invention of ammonium nitrate and polyhalite (65:35 w/w).

FIG. 4 is a photograph of coated granules according to the invention of ammonium nitrate and polyhalite (65:35 w/w).

FIG. 5 is a graph of dust generation along time.

FIG. 6 is a graph of abrasion rate along time.

FIG. 7 is a graph of moisture uptake for different temperatures.

### BRIEF DESCRIPTION OF THE DRAWINGS

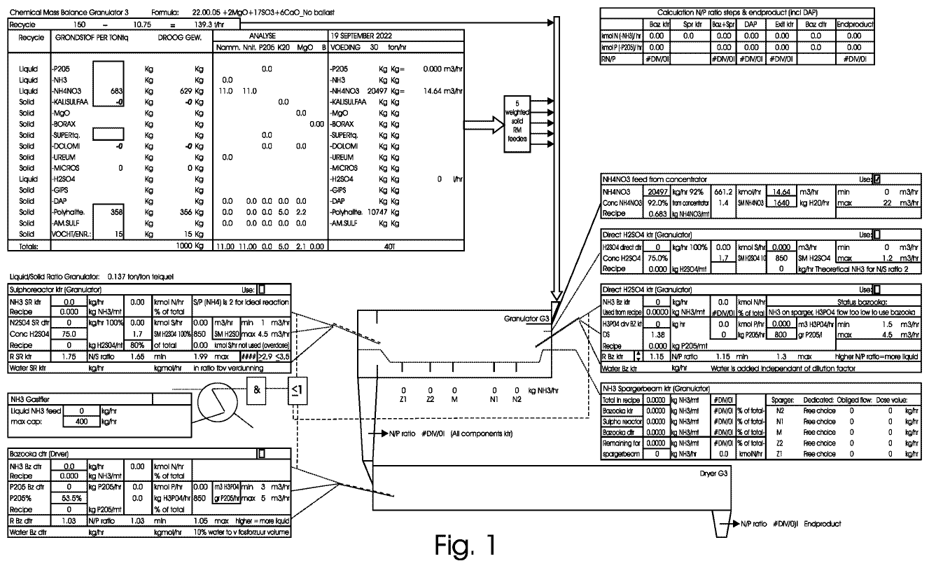

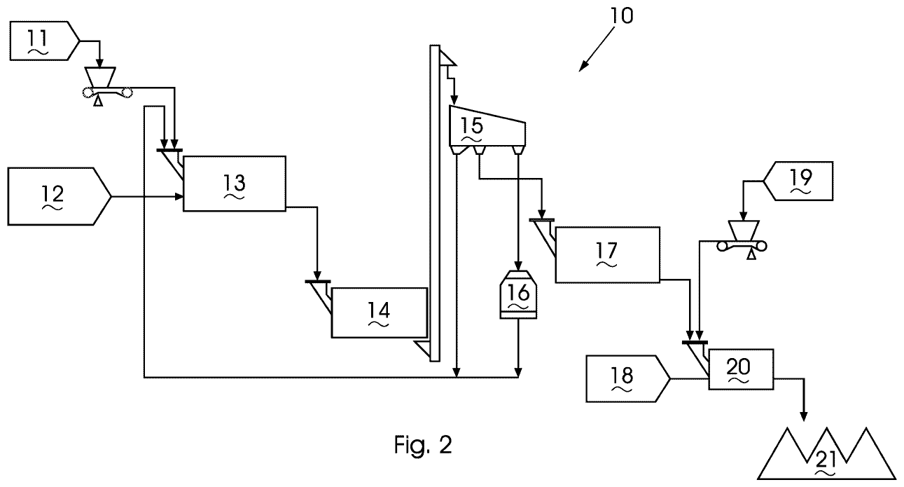

In FIGS. 1 and 2, a conventional granulation process 10 is shown where a drum granulator 13 is used to produce fertiliser granules 21 comprising N, K, S, Mg and Ca. The polyhalite powder 11 feeds a drum granulator 13 in a certain content (kg/h) to achieve the desired concentration of potassium for the final product. In this stage other powders like potassium chloride, magnesium oxide, langbeinite, ammonium sulphate, and/or colemanite can also be added. The ammonium nitrate solution 12 is added into the granulator 13 using a sparger. The ammonium nitrate will start to crystallise due to the temperature drop off on the surface of the solids and the grains will be generated and grow. Water is added to the granulator 13 in order to control the liquid phase. The pH is controlled to above 4.5, and ammonia can be added in a ratio around 2-3 kg/t in case the pH starts to decrease.

The granulation discharge goes to a dryer 14 and where the granules will be dried reaching moistures up to 0.5%. After that the polyhalite and ammonium nitrate granules are classified (through the use of a screening section 15) into the desired particle size and the fines are directed back to the granulator. The courses are milled through a mill 16 and find the fines to make up the recycle that will feed the granulator 13. The particles those fit the desired size go through the cooler 17 and afterwards to a polish/coating drum 20, where (optionally) a talc (to prevent caking) 19 and an oil (to prevent dust generation) 18 are added to coat the grain. The product 21 leaving the cooler 17 should be less the 45 deg C. or at least about 20 deg C. colder than room temperature.

### Example 1

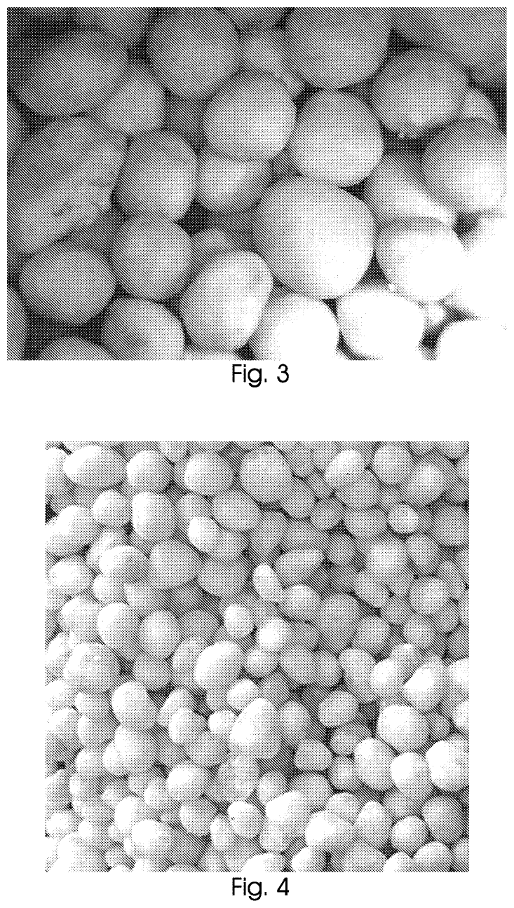

65% by weight of ammonium nitrate solution was pumped onto a drum granulator where powder polyhalite and recycle were present. Powder polyhalite was fed in a ratio of 35% by weight while the recycle rate was maintained in 5.0. The final product had 0.18% of moisture, 21.9% N, 5.0% K (K₂O), 2.15% MgO and 7.35% S (sulphate form). Average crush strength was 8.7 kgf and the product particle size distribution was 98% between 2-5 mm. The product is shown in FIG. 3. A powder and an oil were added after cooling to coat the final product in order to reduce the caking tendency and the dust generation and is shown in FIG. 4. The batch was named Polyhalite Granule containing Ammonium Nitrate (PGAN) “Batch A”.

The above process was repeated and a second batch of granules named PGAN “Batch B” produced.

PGAN Batch A was prepared under 100% Relative Humidity compared to PGAN Batch B that was prepared under drier and warmer conditions.

PGAN Batch B had the following characteristics:

TABLE 1
Nutrient Content (% wt.)

| Nutrient Content | Batch B |
|---|---|
| Total N (%) | 22.0 |
| Nitrogen Ammoniacal (%) | 11.6 |
| Nitrogen Nitric (%) | 10.4 |
| Potassium as K₂O (%) | 4.6 |
| Water Soluble K₂O (%) | 4.4 |
| MgO (%) | 2.3 |
| Water Soluble MgO (%) | 2.2 |
| S (%) | 6.9 |
| SO₃ (%) | 17.6 |
| Water Soluble SO₃ (%) | 17.0 |
| CaO (%) | 6.0 |
| Water Soluble CaO (%) | 3.6 |

TABLE 2
Physical Properties

| Physical Properties - PGAN | % |
|---|---|
| Bulk Density (kg/m3) | 1,180 |
| Moisture (%) | 0.30 |
| Salinity Index | 110 |
| Crush Strength | >4.0 |
| pH | ~5.5 |
| Angle of Repose | 35° |
| True Density | 2.6 |
| Dissolution Rate (1 g/100 ml) | Not fully dissolved |
| | in 1 hour |
| Solubility (g/100 ml @ 20° C.) | 0.85-0.95 |
| Moisture Penetration Test | 1.8-2.4 |

TABLE 3
Size Guide Number (SGN) and Uniformity
Index (UI) Physical Properties

| Physical Properties | |
|---|---|
| PGAN | % |
| SGN | 350.6 |
| UI | 54.6 |
| Granule Size Distribution | >96% |
| | (−#4.7 mm +#2 mm) |

Size Guide Number (SGN) is the average (not median) particle size multiplied by 100.
Uniformity Index (UI) is an expression of particle size uniformity. 40-60 is range for uniform.
Calculated as d95/d10 × 100.

TABLE 4
Moisture Penetration
72 HOUR EXPOSURE @ 30° C., 80% Relative Humidity

| | Moisture | Moisture | Moisture-holding | | |
|---|---|---|---|---|---|
| | absorption | penetration | capacity | | |
| | (mg/cm²) | (cm) | mg/cm³ | | Granules' |
| Sample | x | y | x/y | % | Integrity |
| PGAN - Batch A | 669.4 | 20 | 33.5 | 2.4 | Poor |
| PGAN -Batch B | 482.1 | 20 | 24.1 | 1.8 | Poor |
| CPG | 190.1 | 3 | 63.4 | 3.4 | Fair |
| Ammonium Nitrate | 1528.9 | 20 | 76.4 | 6.4 | Poor |
| (AN) | | | | | |
| CPG + AN Blend | 658.4 | 20 | 32.9 | 2.4 | Poor |
| Calcium Ammonium | 1964.2 | 20 | 98.2 | 6.2 | Poor |
| Nitrate (CAN) | | | | | |

CPG is a Conventional Polyhalite Granule (“CPG”) comprising 99.2% w/w polyhalite and 0.8% w/w corn starch.

TABLE 5
Caking Test Results

1 MONTH

| | Bag | % | Clump |
|---|---|---|---|
| Sample | Hardness* | Clump* | Hardness* |
| PGAN - Batch A | Hard | 0 | none |
| PGAN - Batch B | Light | 0 | none |
| CPG | None | 0 | none |
| Ammonium Nitrate | Hard | 1 | light |
| (AN) | | | |
| CPG + AN Blend | Hard | 1 | light |
| Calcium Ammonium | None | 0 | none |
| Nitrate (CAN) | | | |

*Bag Hardness—after remove the “dummy” weights the tests bags are inspected without moving them from the original position. The inspector “feels” each bag and records bag set as none, light, medium or hard.
*% Clump—% of + 12.5 mm lumps, after test bag dropped twice from 1 m height, then screened very gentle.
*Clump hardness—rated by crushing in the hand. Light can be broken easily. Medium can be broken when pressed against a hard surface. Hard cannot be broken without mechanical means.

TABLE 6
Chemical Evaluations
Chemical Evaluations

| | | PGAN | PGAN |
|---|---|---|---|
| | | Batch A | Batch B |
| Main phases identified and | Polyhalite | 20.4 | 19.1 |
| quantified by XRPD | Anhydrite | 2.2 | 2.1 |
| Polyhalite | Ammonium Nitrate | 44.3 | 57.8 |
| Ammonium Nitrate | Potassium | 21.4 | 11.1 |
| Potassium Ammonium Nitrate | Ammonium Nitrate | | |
| Minor amounts of: | Ammonium Chloride | 3.2 | 2.3 |
| Anhydrite | Sodium Nitrate | 3.4 | 2.1 |
| Ammonium Chlorite | Ammonium Nitrate | 3.8 | 4.5 |
| Sodium Nitrate | Sulphate | | |
| Ammonium Nitrate Sulphate | Ammonium | 1.3 | 1.0 |
| Ammonium Magnesium | Magnesium Sulphate | | |
| Sulphate Hydrate | Hydrate | | |

Quantitative phase analysis of XRPD data by the Rietveld method (wt. %)

TABLE 7
Quantitative Phase Analysis of XRPD Data by the Rietveld Method
(wt. %) of a different sample of Batch B

| Sample | | | | | | | | | | | | | |
|---|---|---|---|---|---|---|---|---|---|---|---|---|---|
| ID | SV | PHL | HL | AHD | MAG | UR | GLB | PAN | AC | SN | ANS | AMSH | Total |
| Batch B | nd | 10.7 | nd | 1.4 | nd | nd | 5.7 | 70.0 | 2.8 | nd | 5.1 | 4.3 | 100 |

In TABLE 7:
nd = not detected
SV = sylvite
PHL = polyhalite
HL = halite
AHD = anhydrite
MAG = magnesite
UR = urea
GLB = glauberite
PAN = potassium ammonium nitrate (gwihabaite-K)
AC = ammonium chloride (salammoniac)
SN = sodium nitrate (nitratine)
ANS = ammonium nitrate sulphate
AMSH = ammonium magnesium sulphate hydrate (boussingaultite)

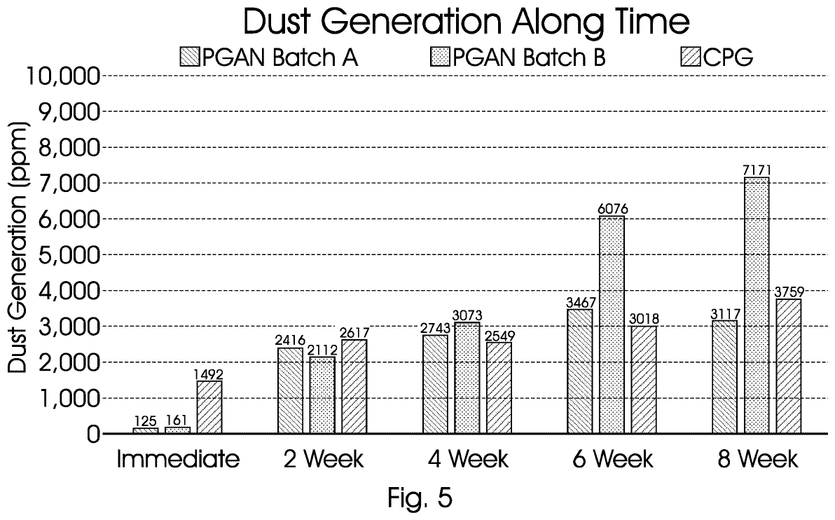

Dust generation as a function of time of both Batch A and Batch B are shown in FIG. 5.

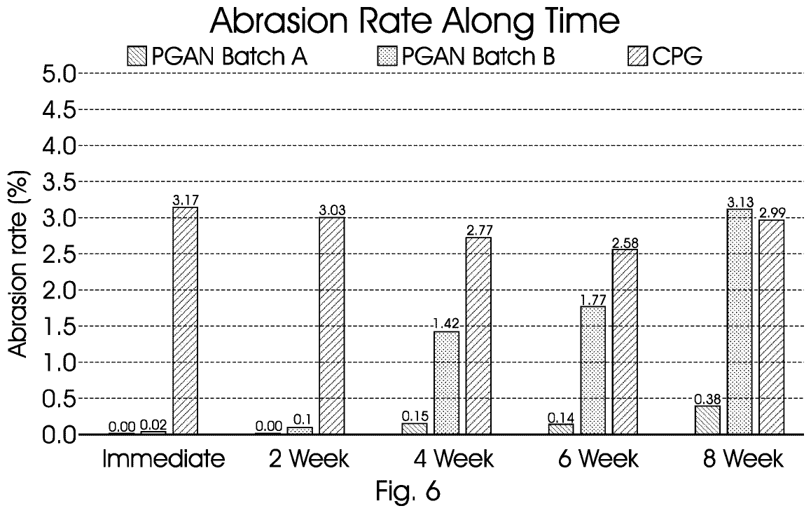

Abrasion rate as a function of time of both Batch A and Batch B are shown in FIG. 6.

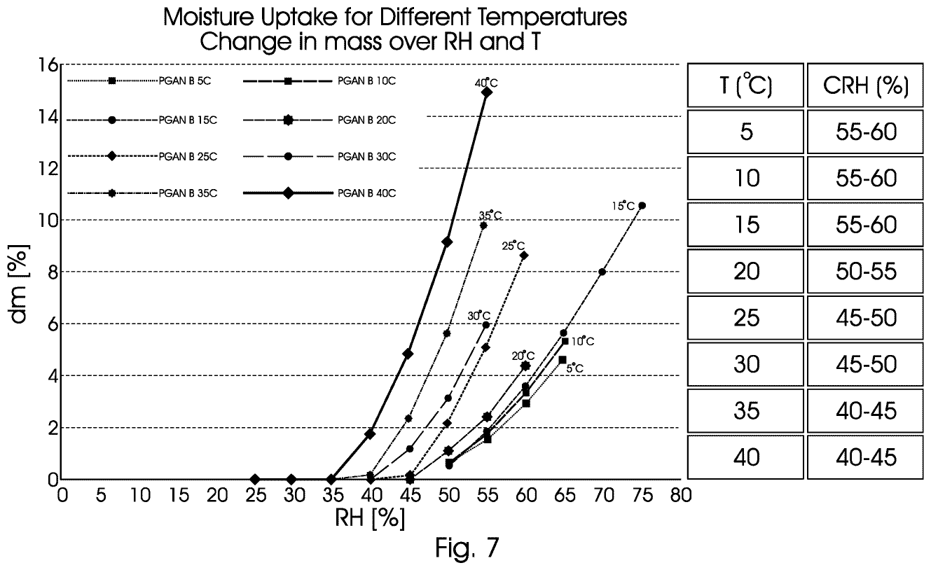

Moisture uptake for different temperatures for Batch B are shown in FIG. 7.

1. A process for the preparation of polyhalite granules comprising the steps of:
a) Providing an aqueous ammonium nitrate (AN) solution;
b) Heating the solution to produce a hot solution;
c) Adding the hot solution to polyhalite; and
d) Allowing the mixture to cool during a granulation process.

2. The process according to claim 1 wherein the aqueous AN solution is concentrated to above 80% by weight AN.

3. The process according to claim 1 wherein the aqueous AN solution is concentrated to around 92% by weight AN.

4. The process according to claim 1 wherein the hot solution is added to a bed of particles and/or powder of polyhalite.

5. The process according to claim 1 wherein the hot AN solution is added in a ratio of from 50:50 to 95:05 by weight to the polyhalite (AN solution:polyhalite).

6. The process according to claim 1 wherein the hot AN solution is heated to a temperature of between 126 and 160 degrees Celsius (deg C.).

7. The process according to claim 1 wherein the process further includes the step of coating the granules with an oil/wax and/or talc combination to prevent moisture uptake, caking and/or dust generation.

8. The process according to claim 1 wherein the process further includes the step wherein the polyhalite granules are screened for physical size with over and under size granules being sent to a recycle circuit.

9. The process according to claim 1 wherein the process utilises a granulator selected from a drum granulator, a pan granulator, a prill tower, an intensive mixer, a high shear, a hot and cold spheronizer, a fluidized bed or any other kind of equipment or combination capable of producing granules.

10. The process according to claim 1 wherein the polyhalite is in combination with another source of potassium including, potassium nitrate, langbeinite and/or potassium sulphate and/or other potassium bearing minerals/substances.

11. The process according to claim 1 wherein boron, colemanite, ulexite, or any combination thereof, and/or zinc oxide or zinc sulphate and molybdenum (as ammonium molybdate or sodium molybdate dihydrate) is added to the polyhalite and/or polyhalite hot AN mixture.

12. The process according to claim 1 wherein the granules have a particle size range of 1.0 mm to 6.0 mm.

13. The process according to claim 1 wherein the process further includes the step of drying the granules using a drier.

14. The process according to claim 13 wherein the drier conditions are not higher than about 300 deg C.

15. A process for the preparation of polyhalite granules where polyhalite is granulated with ammonium nitrate to form potassium nitrate, calcium ammonium nitrate, ammonium nitrate and/or magnesium nitrate and ammonium sulphate.

16. A polyhalite granule comprising polyhalite and potassium ammonium nitrate.

17. The polyhalite granule according to claim 16 comprising at least 10% w/w, 20% w/w, 30% w/w, 40% w/w or 50% w/w potassium ammonium nitrate.

18. The polyhalite granule according to claim 16 produced by a process according to claim 1.

19. The polyhalite granule according to claim 16 wherein the granules further comprise potassium nitrate, calcium ammonium nitrate, ammonium nitrate and/or magnesium nitrate.

20. The polyhalite granule according to claim 16 wherein the granules comprise nitrogen in ammoniacal and/or nitric forms.
